(19) United States
(12) Patent Application Publication
(10) Pub. No.: US 2018/0337507 A1
(43) Pub. Date: Nov. 22, 2018

(54) A LASER SAFETY ADAPTOR FOR USE IN LASER BASED IMAGING SYSTEMS AND RELATED DEVICES

(71) Applicant: East Carolina University, Greenville, NC (US)

(72) Inventors: Zhiyong Peng, Greenville, NC (US); T. Bruce Ferguson, JR., Raleigh, NC (US); Cheng Chen, Greenville, NC (US); Kenneth Michael Jacobs, Greenville, NC (US)

(21) Appl. No.: 15/559,646

(22) PCT Filed: Mar. 24, 2016
(86) PCT No.: PCT/US2016/023963

§ 371 Date: Sep. 19, 2017

Related U.S. Application Data
(60) Provisional application No. 62/138,017, filed on Mar. 25, 2015.

(51) Int. Cl. H01S 3/00; G02B 27/30; G02B 5/02; G02B 27/09; G02B 6/28

(52) U.S. Cl. CPC H01S 3/005; G02B 27/30; G02B 27/0905; G02B 27/0994; G02B 6/2808; G02B 5/0278

(57) ABSTRACT

A fiber assembly is provided including a laser input end configured to receive an input signal having a first laser beam intensity. The fiber assembly further includes a plurality of channels attached to the laser input end and a plurality of laser safety adaptors. Each of the plurality of laser safety adaptors is configured to receive a corresponding one of the plurality of channels. A laser beam exiting each of the plurality of laser safety adaptors has a second laser beam intensity that is less than the first laser beam intensity.

### CLAIM OF PRIORITY

The present application claims priority to U.S. Provisional Application No. 62/138,017, filed Mar. 25, 2015, entitled A Laser Safety for Use in Laser Based Imaging Systems and Related Devices, the disclosure of which is hereby incorporated herein by reference as if set forth in its entirety.

### RESERVATION OF COPYRIGHT

A portion of the disclosure of this patent document contains material which is subject to copyright protection. The copyright owner, East Carolina University of Greenville, N.C., has no objection to the reproduction by anyone of the patent document or the patent disclosure, as it appears in the Patent and Trademark Office patent file or records, but otherwise reserves all copyright rights whatsoever.

### FIELD

The present inventive concept relates generally to lasers and applications thereof and, more particularly, to laser applications involving large field of view (FOV) laser illumination.

### BACKGROUND

In any laser application, safety issues are always a concern. Laser illumination provides an advantage in that energy from a laser beam can be confined optically into a narrow, collimated beam due to its narrow wavelength to produce high energy intensity, which is desirable in many imaging scenarios. However, this high energy intensity may result in injury to a user or equipment when directly exposed to the collimated laser beam.

In most laser imaging systems, the laser beam is expanded to illuminate an area that covers a sample (target region) to be investigated. In far field imaging this can be any field of view (FOV) larger than, for example, 1 cm×1 cm, and in some cases extending up to 10 cm×10 cm. Typically, in conventional methods, a crystal light pipe or optical fiber is used to expand the light beam, so that at certain object distance (>10 cm) the beam is large enough to cover the entire target region. Typically, this expansion results in a cone-shaped beam profile, where the tip of the cone is at the laser energy exit point from the fiber. At this location, the irradiance, i.e. laser power per unit area, can be dangerously high, even if the irradiance at the surface of the imaged object 10 cm away is not dangerous and within laser standard specifications. Thus, there is a risk that the skin of the user could get in close proximity to the tip of the cone, resulting in an injury, even if the exposure time is small.

Passive devices, such as a distance sensor, can be used to ensure the laser energy is delivered within tolerance levels to the samples (image object) surface at a pre-specified distance range. Thus, if the distance is too short or becomes too short, the laser will automatically shut off. Furthermore, with these devices, if any other objects appear in the space between the laser source and the target region, the laser will shut off. Use of these devices, however, has the tendency to cause sporadic unanticipated interruptions to the normal operation of the image acquisition process. Moreover, since the injury from the laser exposure is time-dependent and the exposure may be inadvertently unrecognized, occult injury may occur with delicate tissues even with safety features such as distance sensors and short exposure times because the principle of irradiance.

With the advent of multiple new imaging technologies having wavelength in the 350 nm-1100 nm range, systems and methods directed to laser safety in the imaging applications to reduce the occurrence of injury without sacrificing imaging attributes is highly desirable.

### SUMMARY

Some embodiments of the present inventive concept provide a fiber assembly including a laser input end configured to receive an input signal having a first laser beam intensity. The fiber assembly further includes a plurality of channels attached to the laser input end and a plurality of laser safety adaptors. Each of the plurality of laser safety adaptors is configured to receive a corresponding one of the plurality of channels. A laser beam exiting each of the plurality of laser safety adaptors has a second laser beam intensity that is less than the first laser beam intensity.

In further embodiments of the present inventive concept, each the plurality of laser safety adaptors may include a collimator, a diffuser and a sleeve. The collimator maybe configured to receive the laser beam having the first intensity and re-shape the laser beam to provide a collimated, expanded, and less intense laser beam. The diffuser may be configured to receive the laser beam from the collimator and expand the laser beam such that a deflected beam output from the diffuser is diverged at an angle to cover a relatively large imaging area at a certain distance. The sleeve may be attached to the diffuser configured as a spacer, wherein the laser beam having the second laser beam intensity exits the sleeve.

In still further embodiments, the sleeve may be one of a circular, box shaped or rectangular illumination pattern.

In some embodiments, the assembly may improve laser safety and improves beam homogeneity in single or multi-spectral wavelengths from 350 nm to 1100 nm imaging technologies.

In further embodiments, the assembly may substantially increase laser safety by reducing irradiance levels in close proximity to an imaging device and laser energy exit sources from the imaging device.

In still further embodiments, the assembly may provide homogeneity of a beam profile on an imaging target.

In some embodiments, the assembly may further provide improvement in image quality.

In further embodiments, the plurality of safety adaptors may reduce shadows on the imaged object.

In still further embodiments, the assembly may improve laser safety and beam homogeneity in single or multi-spectral wavelength imaging technologies. In certain embodiments, the imaging technologies may include reflectance imaging, Laser Speckle Imaging, Laser Doppler Imaging, Near-infrared Fluorescence Imaging, and any combination thereof.

Some embodiments of the present inventive concept may provide safety adaptors for a laser. The safety adaptors include a collimator configured to receive a laser beam having a first intensity and re-shape the laser beam to provide a collimated, expanded, and less intense laser beam; a diffuser configured to receive the laser beam from the collimator and expand the laser beam such that a deflected beam output from the diffuser is diverged at an angle to cover a relatively large imaging area at a certain distance; and a sleeve attached to the diffuser configured as a spacer, wherein a laser beam having the second laser beam intensity exits the sleeve.

Further embodiments of the present inventive concept provide methods of providing less intense laser beams using a fiber assembly. The method includes receiving an input signal at a first end of a laser input having a first laser beam intensity; providing the input signal having the first laser beam intensity, from a second end of the laser input, to a plurality of channels attached to the second end laser input end, wherein each of the plurality of channels has a corresponding one of a plurality of laser safety adaptors associated therewith; and providing a laser beam from each of the plurality of laser safety adaptors having a second laser beam intensity that is less than the first laser beam intensity.

### BRIEF DESCRIPTION OF DRAWINGS

FIG. 1 is a block diagram illustrating a fiber in combination with N safety adaptors in accordance with some embodiments of the present inventive concept.

FIG. 2 is a block diagram illustrating functionality of the laser safety adaptor in accordance with some embodiments of the present inventive concept.

FIG. 3 is a diagram illustrating assembly of the laser safety adaptor in accordance with some embodiments of the present inventive concept.

FIGS. 4A and 4B are diagrams illustrating laser light directly out of the fiber (4A) and laser light that out of the laser safety adaptor (4B) in accordance with some embodiments of the present inventive concept.

FIG. 5 is a diagram illustrating aspects of the laser safety adaptor in accordance with some embodiments of the present inventive concept.

### DETAILED DESCRIPTION

Embodiments of the present inventive concept will now be described more fully hereinafter with reference to the accompanying figures, in which preferred embodiments of the inventive concept are shown. This inventive concept may, however, be embodied in many different forms and should not be construed as limited to the embodiments set forth herein. Like numbers refer to like elements throughout. In the figures, layers, regions, elements or components may be exaggerated for clarity. Broken lines illustrate optional features or operations unless specified otherwise.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the inventive concept. The sequence of operations (or steps) is not limited to the order presented in the claims or figures unless specifically indicated otherwise.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

As will be discussed herein, some embodiments of the inventive concept relate generally to lasers and applications thereof and, more particularly, to laser applications involving large field of view (FOV) laser illumination. For example, embodiments of the present inventive concept may be used with single and multi-spectral laser imaging to increase laser safety, and improve beam profile in tissue/organ blood flow and perfusion imaging techniques, such as Laser Speckle Imaging (LSI), Laser Doppler Imaging (LDI), near-infrared fluorescence imaging, and combinations of these imaging techniques with each other or with reflective imaging techniques.

Some embodiments of the present inventive concept use special optics to reduce the laser energy concentrated into a small area when exiting from the tip of a fiber. This concentrated, focused laser energy can be harmful with exposure to skin or the retina of the eye. With a safety adaptor in accordance with embodiments discussed herein installed at the exit point of a fiber or laser illumination device, the laser energy to which an operator of the imaging device might be exposed is diverged in a very short distance so as to significantly spread out the laser energy. Thus, the laser energy exposure to the operator is much lower than a hazard threshold, even if the operator inadvertently touches the illumination system. Embodiments of the present inventive concept provide safety without sacrificing the attributes of laser intensity or imaging capabilities of the device.

In particular, as discussed above, systems and methods directed to laser safety in the imaging applications to reduce the occurrence of injury without sacrificing imaging attributes is highly desirable. Accordingly, some embodiments of the present inventive concept provide a number of optics elements to form a special beam expander attached to an exit point of the laser energy source, for example, a laser port, a tip of a fiber, a tip of a light pipe, and the like. Thus, in accordance with embodiments discussed herein, the laser beam energy may be dispersed into a large area in a very short distance, for example, a few centimeters.

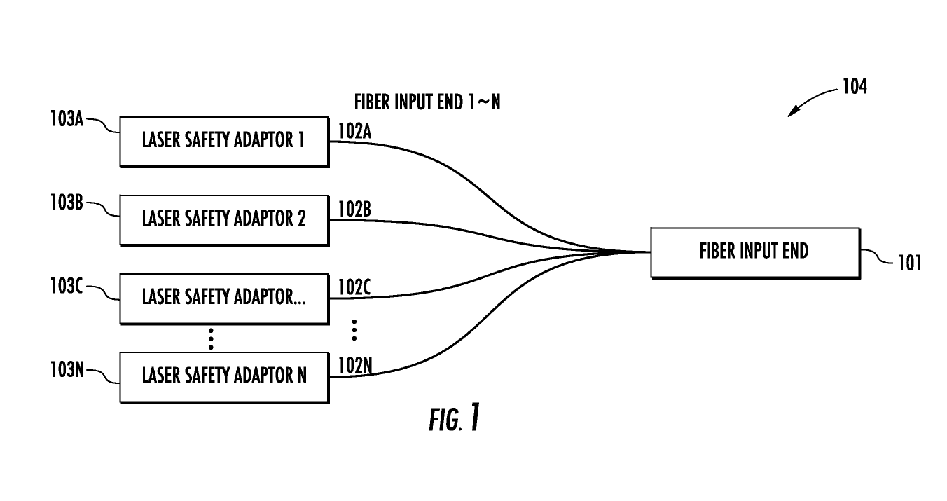

In further embodiments, custom optical fibers are used to split the light into different channels to cover illumination of the field of view (FOV) of the imaged object. This may further decreases the laser energy per unit area of each channel before the light energy enters the special beam expander discussed above. In aggregate, the special beam expander and optical fibers in accordance with some embodiments discussed herein may decrease the light energy per unit area, increase the homogeneity of the laser illumination of the target, maintain the irradiance at the surface of the imaged target, but reduce the risk of excessive irradiance exposure at close proximity to the imaging system and laser source(s) as will be discussed further below with respect to FIGS. 1 through 5.

Referring first to FIG. 1, a diagram illustrating a processor splitting a fiber in accordance with some embodiments of the present inventive concept will be discussed. As illustrated in FIG. 1, an end of a fiber laser beam 101 is split into N channels (102A-102N) to decrease the light intensity. Each channel 102A-102N is then provided to a corresponding laser safety adaptor 103A-103N. It will be understood that although the fiber is split into four channels in FIG. 1, embodiments of the present inventive concept are not limited to this configuration. For example, more or less than four channels may be present without departing from the scope of the present inventive concept.

Referring again to FIG. 1, to reduce the risk of living tissue, for example, a human hand, being exposed to intense laser power during imaging operations, some embodiments of the present inventive concept guide the laser (101) through a multi-leg optical fiber (102A-102N) so that the high energy intensity from the laser source is allocated to N branches, wherein N is greater than two. Each branch receives a same portion of the laser energy. Thus, if N=3, then the laser is split equally between the three channels. In operation, the laser source for illumination is provided into the only input end of a custom made fiber assembly 104. The laser beam is split into N output channels 102A-102N. Each channel has a laser intensity of 1/N of the total input energy, wherein N is the number of output fiber legs (channels). The light from each fiber leg (channel) enters a corresponding laser safety adaptor 103A-103N. Thus, embodiments of the present inventive concept not only provide decreased laser energy per unit area but also increased quality of the beam profile by making the illumination more homogenous. Furthermore, shadows may be reduced, or possibly eliminated, by shedding the light onto the target from different angles, which is desired in many laser imaging applications.

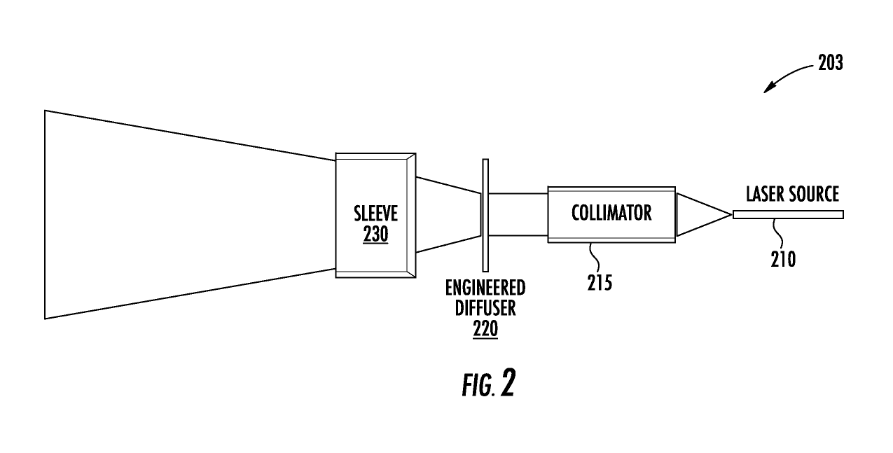

Referring now to FIG. 2, a diagram illustrating a laser safety adaptor 203 in accordance with some embodiments of the present inventive concept will be discussed. As illustrated in FIG. 2, the laser safety adaptor 203 includes a laser source 210, a collimator 215, a diffuser 220 and a sleeve 220. In operation, when the laser light is launched from the source 210, for example, a laser port, fiber tip or light pipe, it is collected and collimated by a collimator 215. The collimator 215 re-shapes the laser beam, which becomes collimated. However, the laser beam exiting the collimator 215 still has a nearly Gaussian energy distribution across the region it shines on and the laser intensity in the center is significantly stronger than the peripheral regions. In some embodiments, the collimator 215 may be any commercially available laser collimator without departing from the scope of the present inventive concept.

From the collimator 215, the laser beam enters a diffuser 220, which expands the laser beam so that the deflected beam output from the diffuser 220 is diverged at a certain angle to cover a relatively large imaging area at a certain distance, for example, 30 cm. The diffuser 220 can be any commercially available laser diffuser without departing from the scope of the present inventive concept. In some embodiments, the laser intensity profile within the illumination area after the diffuser 220 is regulated into a uniform distribution to reduce the likelihood, or possibly prevent, any hot-spot within this illumination area.

The laser beam exits the diffuser 220 and enters a sleeve 230 that is attached to the output surface of the engineered diffuser 220 as a space gap to create an additional safety layer for the laser beam to become even more diverged before it hits any living tissue in its way of propagation. In some embodiments, the sleeve 230 may be a circular sleeve, however, embodiments of the present inventive concept are not limited to this configuration. For example, in some embodiments, the sleeve may be box shaped or rectangular without departing from the scope of the present inventive concept.

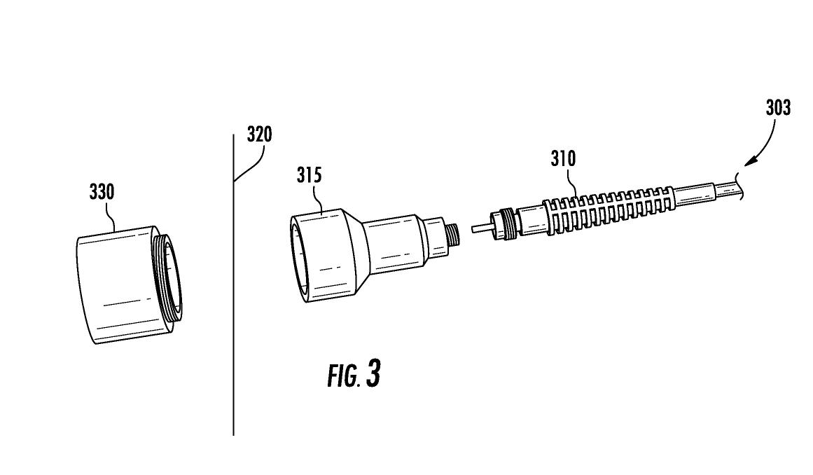

Referring now to FIG. 3, images illustrating an actual laser safety adaptor in accordance with some embodiments of the present inventive concept will be discussed. As illustrated in FIG. 3, a laser safety adaptor 303 includes a laser source 310, a collimator 315, a diffuser 320 and a sleeve 330 as discussed above with respect to FIG. 2. It is clear how these elements of the safety adaptor 303 fit together from FIG. 3.

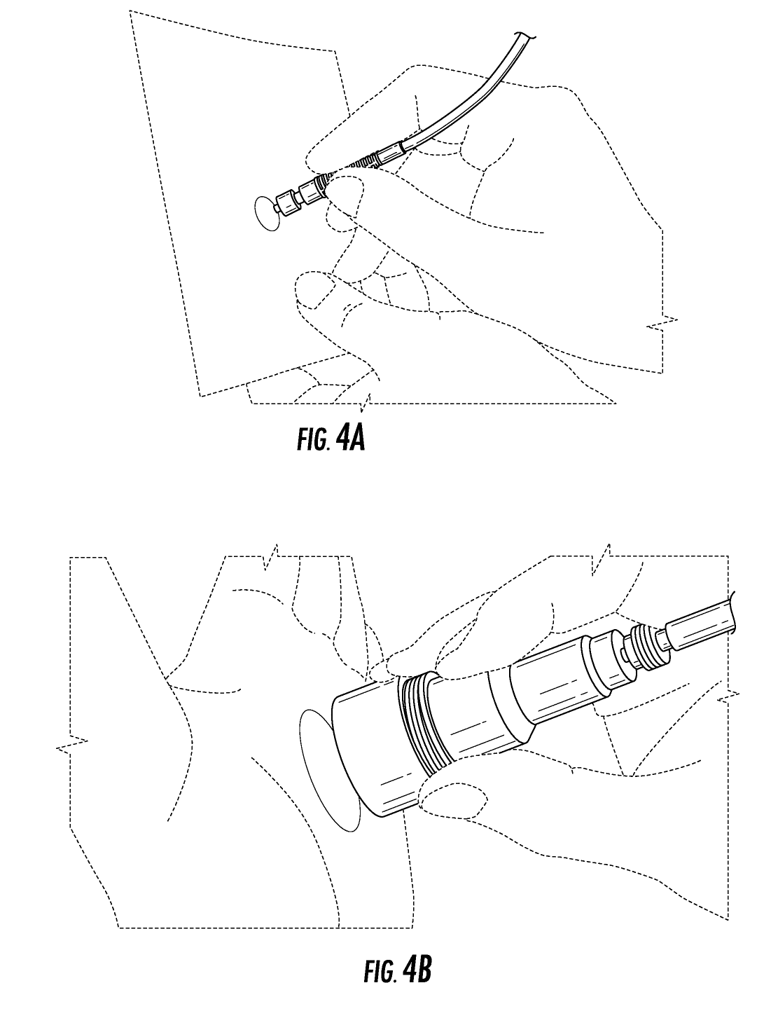

Referring now to FIGS. 4A and 4B, diagrams of laser outputs will be discussed. FIG. 4A illustrates laser light that comes directly out of the fiber and FIG. 4B illustrates laser light that comes out of a laser safety adaptor in accordance with some embodiments of the present inventive concept. In particular, FIG. 4A illustrates a green laser directly shining a piece of paper. It is clear from FIG. 4A how intense the laser beam is when it directly comes out of the laser. It is also clear that the laser energy is concentrated in a small area and the beam profile is more intense in the center.

In stark contrast, FIG. 4B illustrates laser light exiting a laser safety adaptor in accordance with some embodiments of the present inventive concept. In particular, FIG. 4B illustrates that the laser light that comes out of the laser safety adaptor is expended into a relatively large area and the beam profile is significantly more uniform across the illumination area. Experiments have been performed with a 450 mW Class 3b laser in accordance with some embodiments of the present inventive concept. Results showed that a laser light that passes through as laser safety adaptor can directly shine on a human hand without causing any discomfort.

In some embodiments, the optical fiber used for this imaging configuration to launch the laser is a multi-mode optical fiber with a numerical aperture (NA) of, for example, 0.22. When a fiber collimator is attached to the fiber tip, the outgoing beam after the collimator has a diameter of about 16 mm.

A collimated laser beam is still featured by a Gaussian profile, and the light intensity in the central region of the beam is significantly higher than the peripheral regions. When human skin is illuminated by this outgoing beam, it is very likely that the central portion of the laser beam will create physical damage to the living tissue. To reduce the likelihood, or possibly prevent, laser damage due to inhomogeneous laser intensity distribution, the laser safety adaptor according to some embodiments discussed herein includes an engineered diffuser attached to the laser fiber collimator to further diverge the laser beam to a larger area. Furthermore, the diffuser is capable of homogenizing the incoming laser beam, and converting it from a Gaussian profile to a top-hat profile, which means the laser intensity distribution within the beam is nearly uniform to avoid any hidden hot spots.

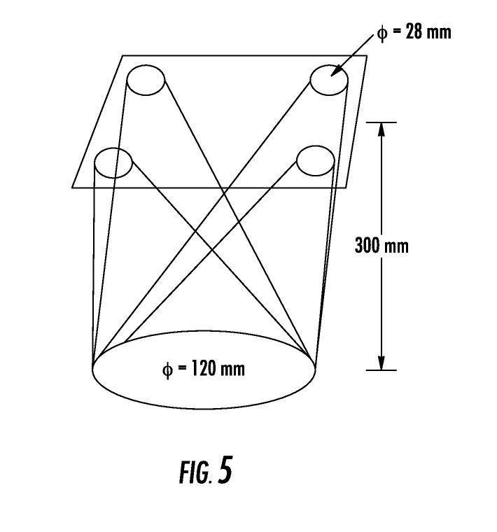

Referring now to FIG. 5, a diagram illustrating the assembly in accordance with some embodiments of the present inventive concept will be discussed. The engineered diffuser used in safety adaptors in accordance with embodiments discussed herein has a diverging angle of about 20 degrees, which can project the laser beam to a circular spot of 120 mm in diameter at a distance of 30 cm away as illustrated in FIG. 5. The engineered diffuser may be positioned in a tubular spacer to allow the beam to diverge freely to an enlarged spot before being launched. This spacer (sleeve) may have a length of 35 mm. Thus, the laser spot has an enlarged beam size of 28 mm in diameter at the exiting port of the tube. During experiments, the maximum power level of a laser used is 1 W, and the laser was evenly split into 4 channels as illustrated. Thus, the laser power in each leg is 0.25 W. Since the laser beam exiting from the spacer has a diameter of 28 mm, equivalent to an area of 6.15 cm², the irradiance intensity at the exiting port of the spacer is uniformly 0.04 W/cm² across the illuminated area within the beam. According to ANSI Z136.1-2000, the American National Standard for Safe Use of Lasers, the Maximal Permissible Exposure (MPE), of laser to human skin is roughly 0.2 W/cm2 in the visible wavelength region (0.4-0.7 m), and roughly 0.33 W/cm2 for 808 nm laser, the near infrared (NOR) region. The irradiance at the exiting port of the laser safety adaptor in accordance with embodiments of the present inventive concept is 0.04 W/cm2, much lower than the MPE in corresponding wavelength regions. Therefore, human skin is safe during imaging manipulations if accidentally exposed to a laser in a wide range of wavelengths. Table 1 below summarizes the MPE (W/cm²) and actual irradiance (W/cm²) for both visible wavelengths and Near infrared (NIR) wavelengths discussed above.

TABLE 1

| | MPE | Actual Irradiance |
|---|---|---|
| | (W/cm²) | (W/cm²) |
| Visible wavelength | 0.2 | 0.04 |
| NIR (808 nm) | 0.33 | 0.04 |

As briefly discussed above, some embodiments of the present inventive concept provide safety adaptors that improve the safety level of large Field of View laser imaging applications, such as Fluorescence Imaging, LSI, and LDI and the like. Some embodiments of the present inventive concept may also provide improved image quality of large Field of View laser imaging applications by making the beam more homogenous, removing the shadow of the target and decreasing the noise caused by laser instability. Thus, some embodiments of the present inventive concept provide systems that improve laser safety and beam homogeneity in laser-based imaging.

Some embodiments of the inventive concept improve laser safety and improve beam homogeneity in single or multi-spectral wavelength (350 nm-1100 nm) imaging technologies, consisting of the two components of a special optics design and device, and the splitting of the laser energy into multiple fibers. Some embodiments include a special optics design and device to achieve rapid beam expansion and diffusion over a short (several cm) distance.

In some embodiments, an optics design is provided that divides the laser fiber into N separate channels, each of which is attached to the special optics design device. These embodiments provide improvement in laser safety and beam homogeneity simultaneously. Improvements in laser safety and beam homogeneity in accordance with embodiments discussed herein can result in prolonged imaging exposure of physiologic processes in the imaged target without increased risk. Furthermore, multiple serial image acquisitions of physiologic processes in the imaged target may be provided without increased risk.

In the drawings and specification, there have been disclosed example embodiments of the inventive concept. Although specific terms are employed, they are used in a generic and descriptive sense only and not for purposes of limitation, the scope of the inventive concept being defined by the following claims.

That which is claimed is:

1. A fiber assembly comprising:
a laser input end configured to receive an input signal having a first laser beam intensity;
a plurality of channels attached to the laser input end; and
a plurality of laser safety adaptors, each of the plurality of laser safety adaptors configured to receive a corresponding one of the plurality of channels,
wherein a laser beam exiting each of the plurality of laser safety adaptors has a second laser beam intensity that is less than the first laser beam intensity.

2. The fiber assembly of claim 1, wherein each the plurality of laser safety adaptors comprise:
a collimator configured to receive the laser beam having the first intensity and re-shape the laser beam to provide a collimated, expanded, and less intense laser beam;
a diffuser configured to receive the laser beam from the collimator and expand the laser beam such that a deflected beam output from the diffuser is diverged at an angle to cover a relatively large imaging area at a certain distance; and
a sleeve attached to the diffuser configured as a spacer, wherein the laser beam having the second laser beam intensity exits the sleeve.

3. The fiber assembly of claim 2, wherein the sleeve comprises one of a circular, box shaped or rectangular illumination pattern.

4. The fiber assembly of claim 1, wherein the assembly improves laser safety and improves beam homogeneity in single or multi-spectral wavelengths from 350 nm to 1100 nm imaging technologies.

5. The assembly of claim 1, wherein the assembly substantially increases laser safety by reducing irradiance levels in close proximity to an imaging device and laser energy exit sources from the imaging device.

6. The assembly of claim 1, wherein the assembly provides homogeneity of a beam profile on an imaging target.

7. The assembly of claim 6, wherein the assembly further provides improvement in image quality.

8. The assembly of claim 1, wherein the plurality of safety adaptors reduce shadows on the imaged object.

9. The assembly of claim 1, wherein the assembly improves laser safety and beam homogeneity in single or multi-spectral wavelength imaging technologies, wherein the imaging technologies comprise reflectance imaging, Laser Speckle Imaging, Laser Doppler Imaging, Near-infrared Fluorescence Imaging, and any combination thereof.

10. A safety adaptor for a laser, the safety adaptor comprising:
a collimator configured to receive a laser beam having a first intensity and re-shape the laser beam to provide a collimated, expanded, and less intense laser beam;
a diffuser configured to receive the laser beam from the collimator and expand the laser beam such that a deflected beam output from the diffuser is diverged at an angle to cover a relatively large imaging area at a certain distance; and
a sleeve attached to the diffuser configured as a spacer, wherein a laser beam having the second laser beam intensity exits the sleeve.

11. The safety adaptor of claim 10, wherein the sleeve comprises one of a circular, box shaped or rectangular illumination pattern.

12. The safety adaptor of claim 10, wherein adaptor improves laser safety and improves beam homogeneity in single or multi-spectral wavelengths from 350 nm to 1100 nm imaging technologies.

13. The safety adaptor of claim 10, wherein the adaptor substantially increases laser safety by reducing irradiance levels in close proximity to an imaging device and laser energy exit sources from the imaging device.

14. The safety adaptor of claim 10, wherein the adaptor provides homogeneity of a beam profile on an imaging target.

15. The safety adaptor of claim 10, wherein the adaptor further provides improvement in image quality.

16. The safety adaptor of claim 10, where the safety adaptors reduces shadows on the imaged object.

17. The safety adaptor of claim 10:
wherein the adaptor improves laser safety and beam homogeneity in single or multi-spectral wavelength imaging technologies; and
wherein the imaging technologies comprise reflectance imaging, Laser Speckle Imaging, Laser Doppler Imaging, Near-infrared Fluorescence Imaging, and any combination thereof.

18. A method of providing less intense laser beams using a fiber assembly, the method comprising:
receiving an input signal at a first end of a laser input having a first laser beam intensity;
providing the input signal having the first laser beam intensity, from a second end of the laser input, to a plurality of channels attached to the second end laser input end, wherein each of the plurality of channels has a corresponding one of a plurality of laser safety adaptors associated therewith; and
providing a laser beam from each of the plurality of laser safety adaptors having a second laser beam intensity that is less than the first laser beam intensity.

19. The method of claim 18, further comprising:
receiving the laser beam having the first intensity and re-shaping the laser beam to provide a collimated, expanded, and less intense laser beam;
receiving, at a diffuser, the laser beam from a collimator and expanding the laser beam such that a deflected beam output from the diffuser is diverged at an angle to cover a relatively large imaging area at a certain distance; and
providing, from a sleeve attached to the diffuser configured as a spacer, a laser beam having the second laser beam intensity.
